(19) United States
(12) Patent Application Publication
(10) Pub. No.: US 2025/0053329 A1
(43) Pub. Date: Feb. 13, 2025

(54) ADDRESS INVALIDATION REPORTING PRIOR TO TRIM COMMAND

(71) Applicant: Micron Technology, Inc., Boise, ID (US)

(72) Inventors: Sampath Ratnam, San Jose, CA (US); Daniel J. Hubbard, Boise, ID (US); Kevin R. Brandt, Boise, ID (US); David Ebsen, Minnetonka, MN (US); Brent Carl Byron, Boise, ID (US)

(21) Appl. No.: 18/786,812

(22) Filed: Jul. 29, 2024

Related U.S. Application Data
(60) Provisional application No. 63/532,146, filed on Aug. 11, 2023.

(51) Int. Cl. G06F 3/06

(52) U.S. Cl. CPC G06F 3/0652; G06F 3/0604; G06F 3/0679

(57) ABSTRACT

Aspects of the present disclosure configure a memory sub-system controller to receive information from a host about invalidated memory addresses. The controller receives, from a host, data identifying a set of storage locations associated with invalidated data stored in a set of memory components and, in response to receiving the data, performs staging activity for the invalidated data stored in the set of storage locations. The controller receives, from the host, a trim command for one or more storage locations in the set of storage locations and performs trim operations for the one or more storage locations for which the staging activity has already been performed.

### PRIORITY APPLICATION

This application claims the benefit of priority to U.S. Provisional Application Ser. No. 63/532,146, filed Aug. 11, 2023, which is incorporated herein by reference in its entirety.

### TECHNICAL FIELD

Examples of the disclosure relate generally to memory sub-systems and, more specifically, to providing adaptive media management for memory components, such as memory dies.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components. Some memory sub-systems arrange their memory components into reclaim groups (RGs), each of which includes sets of reclaim units (RUs). Such memory sub-systems enable a host to control the physical location (e.g., by RG and/or RU via an RU handle) into which data is programmed.

### BRIEF DESCRIPTION OF THE DRAWINGS

The present disclosure will be understood more fully from the detailed description given below and from the accompanying drawings of various examples of the disclosure.

FIG. 1 is a block diagram illustrating an example computing environment including a memory sub-system, in accordance with some examples of the present disclosure.

FIG. 2 is a block diagram of an example media operations manager, in accordance with some implementations of the present disclosure.

FIG. 3 is a block diagram of an example RG system implementation of the memory sub-system, in accordance with some implementations of the present disclosure.

FIG. 4 is a block diagram of an example file deletion process, in accordance with some implementations of the present disclosure.

FIGS. 5 and 6 are flow diagrams of example methods to allow a host to control invalidation of data on a memory sub-system, in accordance with some implementations of the present disclosure.

FIG. 7 is a block diagram illustrating a diagrammatic representation of a machine in the form of a computer system within which a set of instructions can be executed for causing the machine to perform any one or more of the methodologies discussed herein, in accordance with some examples of the present disclosure.

### DETAILED DESCRIPTION

Aspects of the present disclosure configure a system component, such as a memory sub-system controller, to allow a host to control/select the invalidation of data on a memory sub-system prior to issuing/transmitting a trim/discard command. Specifically, the host can identify a set of logical block addresses (LBAs) for a file that needs to be deleted (e.g., selected by a user to be deleted or selected to be deleted by the operating system). Then, the host can report these sets of LBAs to the memory sub-system controller to allow the memory sub-system controller to start performing staging operations for deleting data stored in the set of LBAs prior to receiving a trim/discard command. Upon subsequently receiving the trim/discard command from the host, the memory sub-system controller marks the set of LBAs as invalid. In this way, the host can preemptively warn or notify a memory controller (e.g., of a solid state drive) of LBA invalidations ahead of issuing the trim/discard command. This improves the overall efficiency of operating the memory sub-system.

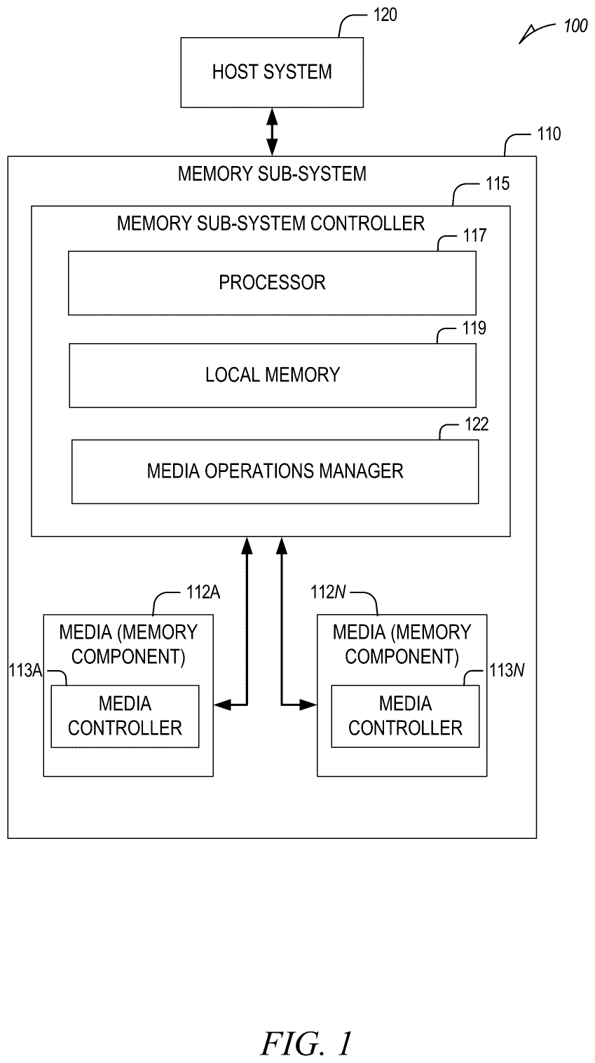

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data.”

In some cases, the memory sub-system includes an optional feature, such as a Flexible Data Placement (FDP) feature that defines replacement groups (RGs) and reclaim units (RUs). This protocol enables remote hosts to control data storage on the memory sub-systems. Some memory sub-systems define or generate virtual memory groups, such as virtual RUs. These virtual memory groups can be implemented by multiple different physical memory components and/or portions of physical memory components. By defining virtual memory groups, the data block size available to a host to store data can be kept constant across different technologies of memory sub-systems and as different portions of various blocks reach their end of life, such as when they reach their maximum PECs.

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data.” “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management, different near miss error correction (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. A dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area than can be erased. Such blocks can be referred to or addressed as logical units (LUN). Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package.

Certain memory systems group the physical memory components into different RGs where each RG includes multiple RUs. The RUs can be of any size that is at least as large as the LUN. Namely, the RU can be the size of a single block or can be the size of a superblock spanning multiple memory dies. These memory systems allow hosts to store data to certain RG and/or to certain RUs within those RGs using corresponding RU handles (write pointers). This provides greater control to the host as to where data is physically stored. Once data is stored to an individual RG, garbage collection operations can be performed but are limited to folding data using the RUs of the individual RG. Namely, in some cases, data cannot be folded into any RU or another RG, but all remains stored in the same RG.

While allowing host devices to control where data is physically stored provides additional flexibility, such processes also introduce inefficiencies in data storage. For example, the need to perform garbage collection operations within the same RG can increase the write amplitude of the memory sub-system. Also, in some cases, data which is stale and no longer needed can be folded in the RG which unnecessarily increases the write amplitude and wastes resources. In addition, in certain memory sub-systems a host can use a trim/discard command to inform the memory controller about which storage locations are invalid and can be discarded. This mechanism enables an operating system to inform a NAND flash solid-state drive (SSD) which data blocks the SSD controller can erase because those data blocks are no longer in use. The trim command enables the operating system (OS) to preemptively notify the memory controller which data pages in a particular block can be erased, allowing the memory controller to manage the storage space available more efficiently for data. Trim command can eliminate any unnecessary copying of discarded or invalid data pages during the garbage collection process to save time and improve the memory sub-system performance. While such systems generally work well, the trim command usually takes a great deal of time to complete because of various staging activity that needs to be performed for data that is scattered across multiple memory portions or blocks. This can slow down the overall memory sub-system and can prolong performing other operations which introduce inefficiencies.

Aspects of the present disclosure address the above and other deficiencies by providing a memory controller that can coordinate with a host as to which memory component portions are associated with invalid data prior to the host issuing/transmitting the trim/discard command. This allows the memory controller to perform staging operations to prepare the memory addresses for deletion (e.g., to be marked invalid) before receiving the trim/discard command. Subsequently, in response to receiving the trim/discard command from the host, the memory addresses can be marked invalid or deleted quickly and efficiently (e.g., because the staging operations have already been performed). This allows the trim/discard command operations to complete faster and reduces lag experienced by the host. This increases the overall efficiency of operating the memory sub-system.

In some examples, the memory controller receives, from a host, data identifying a set of storage locations associated with invalidated data stored in the set of memory components. The memory controller, in response to receiving the data, performs staging activity for the invalidated data stored in the set of storage locations. The memory controller receives, from the host, a trim command for one or more storage locations in the set of storage locations. The memory controller performs trim operations for the one or more storage locations for which staging activity has already been performed.

In some examples, the memory sub-system includes Flexible Data Placement (FDP). In some cases, the memory controller groups the set of memory components into a plurality of RGs, each RG of the plurality of RGs including a subset of RUs. In some examples, the memory controller marks the one or more storage locations as invalid in response to performing the trim operations.

In some examples, the staging activity is performed during a time between receiving the data identifying the set of storage locations and receiving the trim command. In some cases, the one or more storage locations of the trim command include a first portion of a first memory block. In such cases, the memory controller performs garbage collection by copying a second portion of the first memory block to a second memory block without copying the first portion to the second memory block.

In some examples, the one or more storage locations of the trim command include a first portion of a first RU of a subset of RUs of a RG. In such cases, the memory controller performing garbage collection by copying a second portion of the first RU to a second RU of the RG without copying the first portion of the first RU to the second RU.

In some examples, the data identifying the set of storage locations includes a set of logical block addresses (LBAs). In some cases, the host identifies a file to be deleted and determines the set of LBAs associated with the file. The host tags the set of LBAs associated with the file as invalid and transmits a communication to the memory controller identifying the set of LBAs tagged as invalid. In some examples, the invalidated data stored in the set of storage locations is not deleted by the staging activity until the trim command is subsequently received from the host.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples of the present disclosure. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies). Each memory die can include a plurality of planes in which data can be stored or programmed.

In some examples, one of the memory components 112A to 112N can be associated with a first RG and another one of the memory components 112A to 112N can be associated with a second RG. In some cases, a first portion of the memory components 112A to 112N can be associated with a first RU of the first RG and a second portion of the memory components 112A to 112N can be associated with a second RU of the second RG. The memory sub-system 110 can have any number of RGs and any number of RUs within each RG and can, in some cases, can implement the FDP.

In some examples, the first memory component 112A, block, or page of the first memory component 112A, or group of memory components including the first memory component 112A can be associated with a first reliability (capability) grade, value, measure, or lifetime (maximum) PEC. The terms “reliability grade,” “endurance level,” “reliability value” and “reliability measure” are used interchangeably throughout and can have the same meaning. The second memory component 112N or group of memory components including the second memory component 112N can be associated with a second reliability (capability) grade, value, measure, or lifetime (maximum) PEC. In some examples, each memory component 112A to 112N can store respective configuration data that specifies the respective reliability grade and lifetime PEC and current PEC. In some examples, a memory or register can be associated with all of the memory components 112A to 112N and can store a table that maps different RUs, RGs, groups, bins or sets of the memory components 112A to 112N to respective virtual memory groups, reliability grades, lifetime PEC values, and/or current PEC values.

In some examples, a memory or register can be associated with all of the memory components 112A to 112N and can store a table that maps portions of the memory components 112A to 112N to different groups of RGs. The table can specify which set of memory components 112A to 112N maps to or is associated with and grouped with a first RG, and within that set, which portions of the memory components 112A to 112N correspond to RUs within the first RG. The table can also store an indication and keep track of the number of PEC of the first RG. Similarly, the table can specify which other set of memory components 112A to 112N maps to or is associated with and grouped with a second RG, and within that set, which portions of the memory components 112A to 112N correspond to RUs within the second RG. In some cases, the table stores a list of LBAs associated with each RU.

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-systems 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connections or direct communicative connections (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The memory components 112A to 112N can include any combination of the different types of non-volatile memory components and/or volatile memory components. An example of non-volatile memory components includes a negative-and (NAND)-type flash memory. Each of the memory components 112A to 112N can include one or more arrays of memory cells such as single-level cells (SLCs) or multi-level cells (MLCs) (e.g., TLCs or QLCs). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory. In some examples, the memory components 112A to 112N can be, but are not limited to, random access memory (RAM), read-only memory (ROM), dynamic random access memory (DRAM), synchronous dynamic random access memory (SDRAM), phase change memory (PCM), magneto resistive random access memory (MRAM), negative-or (NOR) flash memory, electrically erasable programmable read-only memory (EEPROM), and a cross-point array of non-volatile memory cells.

A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data. For example, a single first row that spans a first set of the pages or blocks of the memory components 112A to 112N can correspond to or be grouped as a first block stripe and a single second row that spans a second set of the pages or blocks of the memory components 112A to 112N can correspond to or be grouped as a second block stripe.

The memory sub-system controller 115 can communicate with the memory components 112A to 112N to perform memory operations such as reading data, writing data, or erasing data at the memory components 112A to 112N and other such operations. The memory sub-system controller 115 can communicate with the memory components 112A to 112N to perform various memory management operations, such as different scan rates, different scan frequencies, different wear leveling, different read disturb management, garbage collection operations, different near miss ECC operations, and/or different dynamic data refresh.

The memory sub-system controller 115 can include hardware, such as one or more integrated circuits and/or discrete components, a buffer memory, or a combination thereof. The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example of the present disclosure, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112A to 112N. The configuration data can describe the lifetime (maximum) PEC values and/or reliability grades associated with different groups of the memory components 112A to 112N and/or different blocks within each of the memory components 112A to 112N and/or different RUs, and/or different RGs.

In some examples, commands or operations received from the host system 120 can include a write command which can specify or identify an individual RG and/or RU within the individual RG to which to program data. Based on the individual RG specified by the write command, the memory sub-system controller 115 can determine the memory components 112A to 112N associated with the individual RG and can generate a write pointer that is used to program the data to the determined memory components 112A to 112N. In some cases, the host system 120 can select an individual RU handle and can program data using the selected individual RU handle. Any data that is written by the host system 120 using the individual RU handle can be stored to a specified RU that is associated with the RU handle. Based on which RU handle is used by the host system 120 to program data, different RUs are used by the host system 120 to physically store the data. In some cases, the host system 120 can track which LBAs are associated with which RU handles and can determine based on the LBAs the RUs in which the data is stored.

In some examples, the commands or operations received from the host system 120 can include a write command, which can specify or identify an individual virtual memory group in which to program data. Based on the virtual memory group specified by the write command, the memory sub-system controller 115 can determine the memory components 112A to 112N (e.g., the RUs, LBAs, and/or RGs) associated with the virtual memory group and can program the data into the determined memory components 112A to 112N. In some cases, the host system 120 can select an individual virtual memory group to invalidate and can issue an invalidate command to the memory sub-system controller 115 identifying the individual virtual memory group. In response, the memory sub-system controller 115 can identify a list of memory components 112A to 112N (e.g., one or more RUs and/or RGs) that are used to store the data for the individual virtual memory group. The memory sub-system controller 115 can then find the valid data in the list of memory components 112A to 112N that belong to another virtual memory group. The memory sub-system controller 115 can then re-write the found valid data from the other virtual memory group to a different memory component(s) 112A to 112N.

The memory sub-system controller 115 can be responsible for other memory management operations, such as wear leveling operations, garbage collection operations, error detection and error-correcting code (ECC) operations, encryption operations, caching operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be a managed memory device (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

The memory sub-system controller 115 can include a media operations manager 122. The media operations manager 122 can be configured to coordinate with host system 120 as to which memory addresses or locations (e.g., LBAs) have been tagged for deletion (e.g., by the operating or file system). The media operations manager 122 can perform a staging activity for such memory addresses or locations ahead of receiving the trim/discard command from the host system 120. Upon receiving the trim/discard command from the host system 120 to delete or invalidate the memory addresses or locations (or portion thereof), the media operations manager 122 can mark data stored in the memory addresses or locations (or portion thereof) as invalid for deletion without re-performing or having to perform the staging activity. This increases the overall efficiency of operating the memory sub-system 110.

Specifically, the media operations manager 122 can receive, from the host system 120, data identifying a set of storage locations (e.g., LBAs) associated with invalidated data stored in a set of memory components. The media operations manager 122 can, in response to receiving the data, perform staging activity for the invalidated data stored in the set of storage locations. The media operations manager 122 receives, from the host system 120, a trim command for one or more storage locations in the set of storage locations and performs trim operations for the one or more storage locations for which a staging activity has already been performed.

Depending on the example, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein. Further details with regards to the operations of the media operations manager 122 are described below.

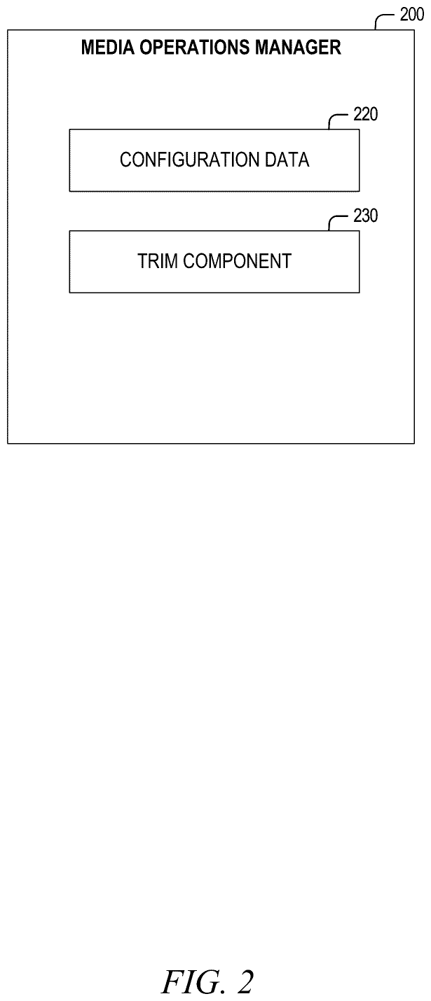

FIG. 2 is a block diagram of an example media operations manager 200 (corresponding to media operations manager 122 of FIG. 1), in accordance with some implementations of the present disclosure. As illustrated, the media operations manager 200 includes configuration data 220 and a trim component 230. For some examples, the media operations manager 200 can differ in components or arrangement (e.g., less, or more components) from what is illustrated in FIG. 2.

The configuration data 220 accesses and/or stores configuration data associated with the memory components 112A to 112N of FIG. 1. In some examples, the configuration data 220 is programmed into the media operations manager 200. For example, the media operations manager 200 can communicate with the memory components 112A to 112N to obtain the configuration data and store the configuration data 220 locally on the media operations manager 122. In some examples, the media operations manager 122 communicates with the host system 120 of FIG. 1. The host system 120 receives input from an operator or user that specifies parameters including virtual memory group assignments to physical memory components, lifetime (maximum) PEC values of different bins, groups, blocks, block stripes, memory dies, RUs, RGs, and/or sets of the memory components 112A to 112N, and/or group assignments that define the sizes of different RU and RGs. The media operations manager 122 can receive configuration data from the host system 120 and stores the configuration data in the configuration data 220.

The configuration data 220 can store a map that identifies which sets of memory components 112A to 112N are used to implement different RGs. The configuration data 220 can store a table that maps different virtual memory groups to different physical memory components 112A to 112N (e.g., different RUs, RGs, and/or LBAs). For example, the configuration data 220 can store a map that associates a first RG with a first portion of the memory components 112A to 112N (e.g., a first die or first set of LBAs) and that associates a second RG with a second portion of the memory components 112A to 112N (e.g., a second die or second set of LBAs). The configuration data 220 can store a table that associates a first virtual memory group with a first portion of the memory components 112A to 112N (e.g., a first die, a first portion of a first RU) and that associates a second virtual memory group with a second portion of the memory components 112A to 112N (e.g., a second die or second portion of the first RU and a first portion of a second RU). The map can store an indication of the physical addresses or LUN of the first portion of the memory components 112A to 112N associated with the first RG and/or virtual memory group and an indication of the physical addresses or LUN of the second portion of the memory components 112A to 112N associated with the second RG and/or virtual memory group.

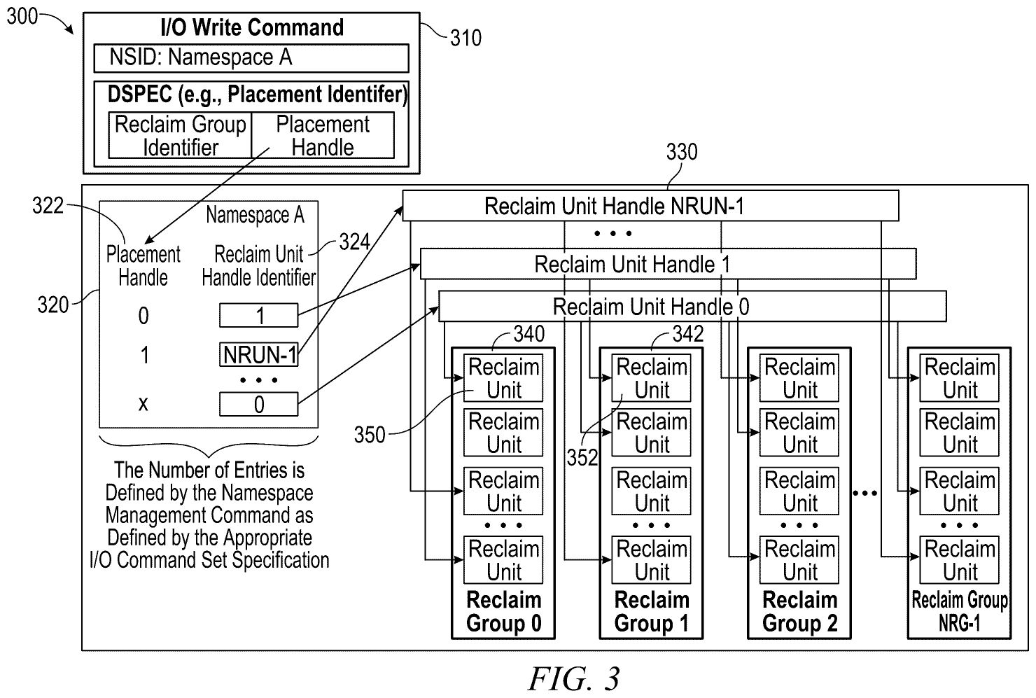

For example, FIG. 3 is a block diagram of an example RG system 300 implementation of the memory sub-system 110 of FIG. 1. The RG system 300 includes a placement handle component 320 that is used to store the map of different groups (e.g., the map stored by the configuration data 220). The RG system 300 can receive a write command 310 that specifies at least an RG and/or a placement handle. The placement handle component 320 can search the map using the placement handle 322 to identify the RU 324 associated with the specified RG. The RG system 300 can then generate a write pointer 330 to write data to the identified RU 324.

As shown in FIG. 3, multiple RGs are defined. For example, the RG system 300 includes a first RG 340 and a second RG 342. The first RG 340 includes a first group of RUs 350. The second RG 342 includes a second group of RUs 352. In some cases, the first RG 340 can represent a single memory die and the second RG 342 represents another single memory die. Each RU in the first group of RUs 350 is implemented by a portion of the memory components 112A to 112N of FIG. 1, such as blocks, planes, superblocks, pages, and so forth. Similarly, each RU in the second group of RUs 350 is implemented by a different portion of the memory components 112A to 112N, such as blocks, planes, superblocks, pages, and so forth. All of the garbage collection operations performed within RUs of an individual RG can be constrained to that individual RG. For example, garbage collection operations performed on an individual RU of the first group of RUs 350 fold data using only the RUs in the first group of RUs 350, and garbage collection operations performed on an individual RU of the second group of RUs 352 fold data using only the RUs in the second group of RUs 352.

Referring back to FIG. 2, the trim component 230 coordinates with the host system 120 as to which LBAs are tagged by the file system or operating system for deletion and can use that information to perform a staging activity prior to receiving the trim/discard command from the host system 120. This can expedite the performance of the trim/discard operations which improves the efficiency of the memory sub-system 110.

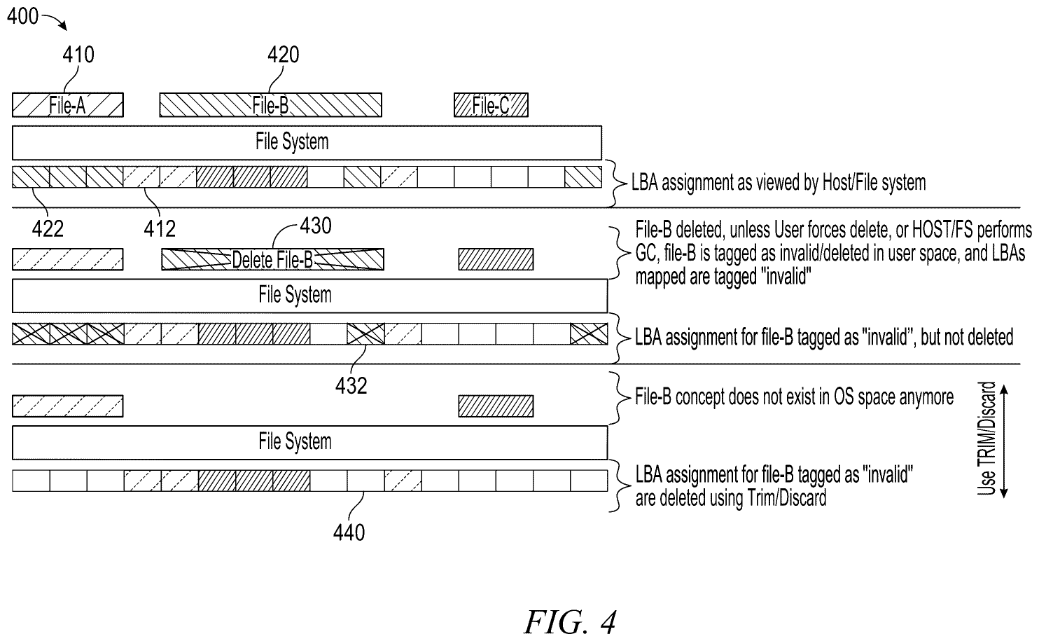

FIG. 4 shows an example file deletion process 400, according to some examples. As shown in the file deletion process 400, the host system 120 can generate multiple files including a first file 410 and a second file 420. In such cases, the host system 120 of FIG. 1 can store data or program data to the memory sub-system 110. The memory sub-system 110 can provide to the host system 120 a list of storage locations (e.g., LBAs) associated with each of the multiple files. For example, the host system 120 can receive from the memory sub-system controller 115 of FIG. 1 a first set of LBAs 422 representing portions of the memory components 112A to 112N on which data for the second file 420 is stored. In some cases, the first set of LBAs 422 correspond to a portion of a first RU of an individual RG. As another example, the host system 120 can receive from the memory sub-system controller 115 a second set of LBAs 412 representing portions of the memory components 112A to 112N of FIG. 1 on which data for the first file 410 is stored. In some cases, the second set of LBAs 412 correspond to a second portion of the first RU (or a second RU) of the individual RG.

The host system 120 can receive a command (e.g., from the user and/or from an operating system) to delete the second file 420. In such cases, the host system 120 can move the second file 420 into a deletion folder to mark the second file 420 as a deleted file 430. The host system 120 can also identify the first set of LBAs 432 associated with the second file 420 and tag the first set of LBAs 432 as invalid but not deleted. The host system 120 can generate a communication that identifies the first set of LBAs 432 as possible LBAs to be deleted. The host system 120 can transmit the communication identifying the first set of LBAs 432 to the trim component 230 of FIG. 2. The trim component 230 can initiate performing staging activity to prepare the portions of the memory components 112A to 112N associated with the first set of LBAs 432 for deletion.

Subsequently, at a later time after the communication is transmitted to the memory sub-system controller 115, the host system 120 can transmit a trim/discard command to the trim component 230. The trim/discard command can specify the first set of LBAs 432 and/or portion thereof as well as other LBAs to be marked as invalid to be deleted. The storage locations specified in the trim/discard command can be a subset (e.g., less than all) of the storage locations previously identified by the host system 120 as possibly being deleted and for which staging activity has been performed. In some examples, the host system 120 can identify and communicate to the trim component 230 multiple sets of LBAs associated with multiple files to be deleted. The trim component 230 can initiate staging activity for all of the sets of LBAs associated with the multiple files. Then, the host system 120 can send a trim/discard command that specifies only one of the multiple files for deletion. This can cause the trim component 230 to mark only the LBAs associated with the only one of the multiple files as invalid without making any LBAs associated with other files of the multiple files. As such, the memory sub-system controller 115 can perform staging activity for LBAs that may not all be deleted by a subsequently received trim/discard command.

In some examples, between the time at which the command identifying the first set of LBAs 432 and when the trim/discard command is received, the memory sub-system controller 115 can continue or complete performing the staging activity. Then, in response to receiving the trim/discard command from the host system 120, the memory sub-system controller 115 can mark the storage locations 440 associated with the first set of LBAs 432 as invalid. Since the staging activity has already been performed for the first set of LBAs 432, the memory sub-system controller 115 can more quickly mark the storage locations 440 as invalid without having to perform the staging activity when the trim/discard command is received.

The trim component 230 can perform garbage collection operations by moving valid data from a first portion of the memory components 112A to 112N to a second portion of the memory components 112A to 112N and ignoring or not moving the invalid data. In such cases, the trim component 230 can copy the data stored in second set of LBAs 412 of the first portion of the memory components 112A to 112N which is still valid to a second portion of the memory components 112A to 112N. The trim component 230 can discard or avoid copying the storage locations 440 associated with the second file 420 into the second portion of the memory components 112A to 112N. This causes the data stored in the storage locations 440 to be deleted.

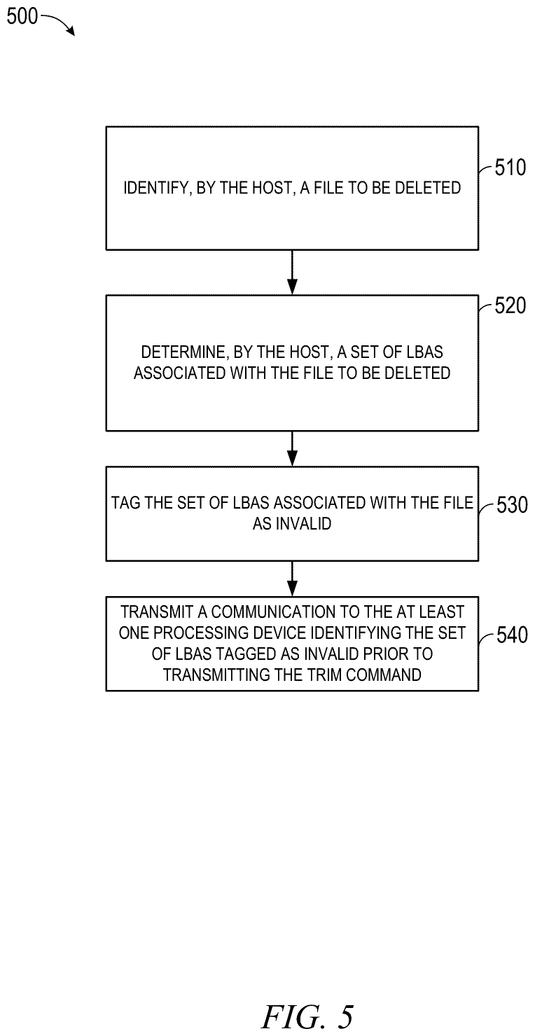

FIG. 5 is a flow diagram of an example method 500 to allow a host to control the invalidation of data on the memory sub-system, in accordance with some implementations of the present disclosure. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 5, the method (or process) 500 begins at operation 510, with a host system 120 of FIG. 1 identifying a file to be deleted. Then, at operation 520, the host system 120 determines a set of LBAs associated with the file to be deleted and, at operation 530, the host system 120 tags the set of LBAs associated with the file as invalid. At operation 540, the host system 120 transmits a communication to the memory sub-system controller 115 identifying the set of LBAs tagged as invalid prior to transmitting the trim command.

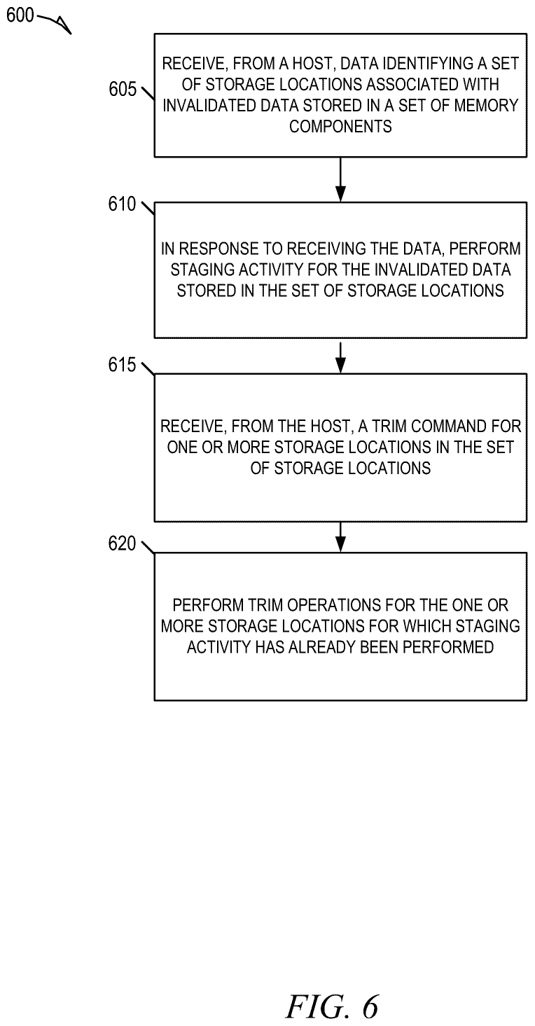

FIG. 6 is a flow diagram of an example method 600 to allow a host to control the invalidation of data on the memory sub-system, in accordance with some implementations of the present disclosure. The method 600 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 600 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 6, the method (or process) 600 begins at operation 605, with a media operations manager 122 of a memory sub-system (e.g., memory sub-system 110) receiving, from the host system 120 of FIG. 1, data identifying a set of storage locations associated with invalidated data stored in a set of memory components. Then, at operation 610, the media operations manager 122 in response to receiving the data, performs a staging activity for the invalidated data stored in the set of storage locations and, at operation 615, receives, from the host system 120, a trim command for one or more storage locations in the set of storage locations. At operation 620, the media operations manager 122 performs trim operations for the one or more storage locations for which staging activity has already been performed.

For example, as part of performing staging activity, the media operations manager 122 can perform various operations. Specifically, the media operations manager 122 can avoid folding storage locations (e.g., LBAs) flagged as impending trims (impending trim command from the host system 120) unless needed for data integrity. This can also help lower the write amplification. The media operations manager 122 can relocate (copy to new blocks) other valid data in one or more blocks containing the data stored in the set of storage locations associated with the invalidated data to be trimmed. This can be done when it makes sense to do so, such as when the remaining valid data is small enough (e.g., is of a size smaller than a threshold) to cause an instantaneous write amplification that is lower than the average write amplification once the flagged data is actually trimmed (e.g., when the trim command for the marked storage locations is received). The media operations manager 122 can consider the impending trim hints (e.g., the storage locations identified by the host system 120 as soon to be trimmed by a trim command) in the greedy selection (for garbage collection) algorithm. For example, the media operations manager 122 can avoid choosing the superblock or block with impending trims even if the block or superblock is currently a good candidate because the block may be an even better candidate once the trims happen. The media operations manager 122 can, determine that the time lag from the trim warning (e.g., from when the storage locations to be subsequently trimmed are identified by the host system 120) to the actual trim (e.g., when the trim command is received from the host system 120) is large compared to a threshold value. In such cases, the media operations manager 122 can retain such storage locations to the same superblock or block. This can also help reduce overall write amplification.

In view of the disclosure above, various examples are set forth below. It should be noted that one or more features of an example, taken in isolation or combination, should be considered within the disclosure of this application.
Example 1: A system comprising: a set of memory components of a memory sub-system; and at least one processing device operatively coupled to the set of memory components, the at least one processing device being configured to perform operations comprising: receiving, from a host, data identifying a set of storage locations associated with invalidated data stored in the set of memory components; in response to receiving the data, performing staging activity for the invalidated data stored in the set of storage locations; receiving, from the host, a trim command for one or more storage locations in the set of storage locations; and performing trim operations for the one or more storage locations for which staging activity has already been performed.
Example 2. The system of Example 1, wherein the memory sub-system includes Flexible Data Placement (FDP).
Example 3. The system of Example 2, the operations further comprising: grouping the set of memory components into a plurality of reclaim groups (RGs), each RG of the plurality of RGs comprising a subset of reclaim units (RUs).
Example 4. The system of any one of Examples 1-3, the operations comprising: marking the one or more storage locations as invalid in response to performing the trim operations.
Example 5. The system of any one of Examples 1-4, wherein the staging activity is performed during a time between receiving the data identifying the set of storage locations and receiving the trim command.
Example 6. The system of any one of Examples 1-5, wherein the one or more storage locations of the trim command comprise a first portion of a first memory block, the operations comprising: performing garbage collection by copying a second portion of the first memory block to a second memory block without copying the first portion to the second memory block.
Example 7. The system of any one of Examples 1-6, wherein the one or more storage locations of the trim command comprise a first portion of a first reclaim unit of a subset of reclaim units of a reclaim group, the operations comprising: performing garbage collection by copying a second portion of the first reclaim unit to a second reclaim unit of the reclaim group without copying the first portion of the first reclaim unit to the second reclaim unit.
Example 8. The system of any one of Examples 1-7, wherein the data identifying the set of storage locations comprises a set of logical block addresses (LBAs).
Example 9. The system of Example 8, wherein the host performs operations comprising: identifying, by the host, a file to be deleted; determining, by the host, the set of LBAs associated with the file; tagging the set of LBAs associated with the file as invalid; and transmitting a communication to the at least one processing device identifying the set of LBAs tagged as invalid prior to transmitting the trim command.
Example 10. The system of any one of Examples 1-9, wherein the invalidated data stored in the set of storage locations is not deleted by the staging activity until the trim command is subsequently received from the host.

Methods and computer-readable storage medium with instructions for performing any one of the above Examples.

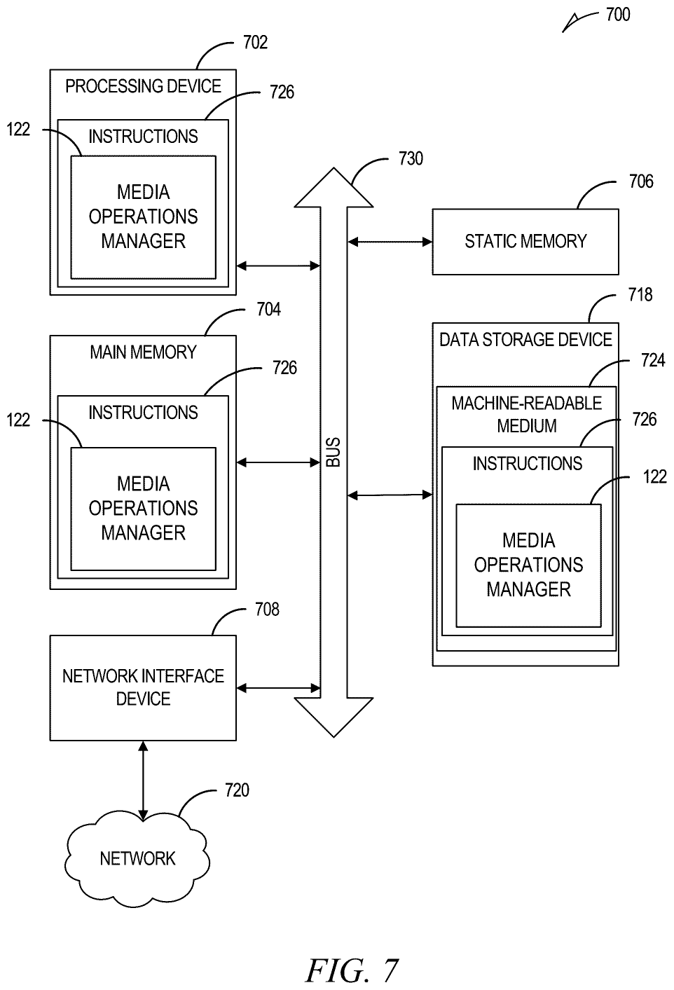

FIG. 7 illustrates an example machine in the form of a computer system 700 within which a set of instructions can be executed for causing the machine to perform any one or more of the methodologies discussed herein. In some examples, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

The processing device 702 represents one or more general-purpose processing devices such as a microprocessor, a central processing unit, or the like. More particularly, the processing device 702 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 702 can also be one or more special-purpose processing devices such as an application specific integrated circuit (ASIC), a field programmable gate array (FPGA), a digital signal processor (DSP), a network processor, or the like. The processing device 702 is configured to execute instructions 726 for performing the operations and steps discussed herein. The computer system 700 can further include a network interface device 708 to communicate over a network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one example, the instructions 726 implement functionality corresponding to the media operations manager 122 of FIG. 1. While the machine-readable storage medium 724 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); crasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thercon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, the disclosure has been described with reference to specific examples thereof. It will be evident that various modifications can be made thereto without departing from the broader scope of the disclosure as set forth in the following claims. The specification and drawings are, accordingly, to be regarded in an illustrative sense rather than a restrictive sense.

What is claimed is:

1. A system comprising:
a set of memory components of a memory sub-system; and
at least one processing device operatively coupled to the set of memory components, the at least one processing device being configured to perform operations comprising:
receiving, from a host, data identifying a set of storage locations associated with invalidated data stored in the set of memory components;
in response to receiving the data, performing staging activity for the invalidated data stored in the set of storage locations;
receiving, from the host, a trim command for one or more storage locations in the set of storage locations; and
performing trim operations for the one or more storage locations for which staging activity has already been performed.

2. The system of claim 1, wherein the memory sub-system includes Flexible Data Placement (FDP).

3. The system of claim 2, the operations further comprising:
grouping the set of memory components into a plurality of reclaim groups (RGs), each RG of the plurality of RGs comprising a subset of reclaim units (RUs).

4. The system of claim 1, the operations comprising:
marking the one or more storage locations as invalid in response to performing the trim operations.

5. The system of claim 1, wherein the staging activity is performed during a time between receiving the data identifying the set of storage locations and receiving the trim command.

6. The system of claim 1, wherein the one or more storage locations of the trim command comprise a first portion of a first memory block, the operations comprising:
performing garbage collection by copying a second portion of the first memory block to a second memory block without copying the first portion to the second memory block.

7. The system of claim 1, wherein the one or more storage locations of the trim command comprise a first portion of a first reclaim unit of a subset of reclaim units of a reclaim group, the operations comprising:
performing garbage collection by copying a second portion of the first reclaim unit to a second reclaim unit of the reclaim group without copying the first portion of the first reclaim unit to the second reclaim unit.

8. The system of claim 1, wherein the data identifying the set of storage locations comprises a set of logical block addresses (LBAs).

9. The system of claim 8, wherein the host performs operations comprising:
identifying, by the host, a file to be deleted;
determining, by the host, the set of LBAs associated with the file;
tagging the set of LBAs associated with the file as invalid; and
transmitting a communication to the at least one processing device identifying the set of LBAs tagged as invalid.

10. The system of claim 1, wherein the invalidated data stored in the set of storage locations is not deleted by the staging activity until the trim command is subsequently received from the host.

11. A method comprising:
receiving, from a host, data identifying a set of storage locations associated with invalidated data stored in a set of memory components;
in response to receiving the data, performing staging activity for the invalidated data stored in the set of storage locations;
receiving, from the host, a trim command for one or more storage locations in the set of storage locations; and
performing trim operations for the one or more storage locations for which staging activity has already been performed.

12. The method of claim 11, wherein a memory sub-system comprising the set of memory components includes Flexible Data Placement (FDP).

13. The method of claim 12, further comprising:
grouping the set of memory components into a plurality of reclaim groups (RGs), each RG of the plurality of RGs comprising a subset of reclaim units (RUs).

14. The method of claim 11, comprising:
marking the one or more storage locations as invalid in response to performing the trim operations.

15. The method of claim 11, wherein the staging activity is performed during a time between receiving the data identifying the set of storage locations and receiving the trim command.

16. The method of claim 11, wherein the one or more storage locations of the trim command comprise a first portion of a first memory block, comprising:
performing garbage collection by copying a second portion of the first memory block to a second memory block without copying the first portion to the second memory block.

17. The method of claim 11, wherein the one or more storage locations of the trim command comprise a first portion of a first reclaim unit of a subset of reclaim units of a reclaim group, comprising:
performing garbage collection by copying a second portion of the first reclaim unit to a second reclaim unit of the reclaim group without copying the first portion of the first reclaim unit to the second reclaim unit.

18. The method of claim 11, wherein the data identifying the set of storage locations comprises a set of logical block addresses (LBAs).

19. The method of claim 18, wherein the host performs operations comprising:
identifying, by the host, a file to be deleted;
determining, by the host, the set of LBAs associated with the file;
tagging the set of LBAs associated with the file as invalid; and
transmitting a communication to at least one processing device associated with the set of memory components identifying the set of LBAs tagged as invalid prior to transmitting the trim command.

20. A non-transitory computer-readable storage medium comprising instructions that, when executed by at least one processing device, cause the at least one processing device to perform operations comprising:
receiving, from a host, data identifying a set of storage locations associated with invalidated data stored in a set of memory components;
in response to receiving the data, performing a staging activity for the invalidated data stored in the set of storage locations;
receiving, from the host, a trim command for one or more storage locations in the set of storage locations; and
performing trim operations for the one or more storage locations for which the staging activity has already been performed.
